(19) United States
(12) Patent Application Publication
(10) Pub. No.: US 2008/0110213 A1
(43) Pub. Date: May 15, 2008

(54) Washing Machine With Double Rotor Type Motor

(76) Inventors: Soung Bong Choi, Gyeongsangnam-do (KR); Hung Myong Cho, Gyeongsangnam-do (KR)

Correspondence Address: KED & ASSOCIATES, LLP, P.O. Box 221200, Chantilly, VA, 20153-1200, US

(21) Appl. No.: 11/547,009

(22) PCT Filed: Jan. 26, 2006
(86) PCT No.: PCT/KR06/00298

§ 371 Date: Jul. 16, 2007

(30) Foreign Application Priority Data
Feb. 1, 2005 (KR) 10-2005-0009155

(51) Int. Cl. D06F 37/20; H02K 1/22

(52) U.S. Cl. 68/140

(57) ABSTRACT

The present invention relates to washing machines, and more particularly, to a washing machine with a double rotor type motor. The washing machine includes a rub for holding washing water, a double rotor having an outer rotor with outer magnets supported on an inside circumferential surface, and an inner rotor on an inner side of the outer rotor with inner magnets supported on outside circumferential surface, a bearing housing having a hub at a rear of the tub for supporting a rotation shaft connected to the double rotor, and extensions from the hub fixed to an outer surface of the tub, and a stator having cores with opposite surfaces arranged to face the outer magnets and the inner magnets, a coil wound on an outside surface of each of the cores, with an insulating material applied to an outside surface, a molded portion insert molded to outside surfaces of the core and coil such that the opposite surfaces of the cores are exposed, and a fastening portion extended from the molded portion and secured to the hub.

### TECHNICAL FIELD

The present invention relates to washing machines, and more particularly, to a washing machine with a double rotor type motor.

### BACKGROUND ART

In general, the washing machine washes laundry by using friction between washing water and the laundry in a drum rotated by a motor in a state detergent, washing water, and the laundry is introduced into the drum. The drum is a washing tub for holding washing water and the laundry, and applicable to the washing machine, irrespective of the washing machine being of a drum type or a pulsator type.

In the meantime, depending on driving types of the washing machine, there are indirect coupling type in which driving power is transmitted from the motor to the drum indirectly through a belt wound around a motor pulley and a drum pulley, and a direct coupling type in which the motor is directly coupled to the drum, to transmit driving power from the motor to the drum, directly.

The type of washing machine in which driving power is transmitted from the motor to the drum indirectly through a belt wound around a motor pulley and a drum pulley causes an energy loss in a course of the driving power transmission, and generates much noise in the power transmission course. Consequently, in order to solve such problems, it is a recent trend that use of washing machines having the direct coupling drum type motors applied thereto increases.

FIG. 1 illustrates a section of a related art drum type washing machine with a motor.

Referring to FIG. 1, there is a tub 2 in a cabinet 1, with a drum 3 rotatably mounted on a center of an inside of the tub 2.

At a rear of the tub 2, there is a motor having a stator 6 and a rotor 5, wherein the stator 6 is fixedly secured to a rear wall of the tub, and the rotor 5 surrounds the stator 6, and is fixed to a shaft passed through the tub and connected to the drum 3. Though not shown in detail, on an inside surface of the rotor 5, there are magnets of opposite poles arranged alternately.

In the meantime, there is a door 21 on a front of the cabinet 1, with a gasket 22 between the door 21 and the tub 2. There are hanging springs 23 between an inside of an upper side of the cabinet 1 and an upper side of an outside circumference of the tub 2, for suspending the tub 2, and friction dampers 24 between an inside of a lower side of the cabinet 1 and a lower side of an outside circumference of the tub 2 for damping vibration of the tub 2 generated in spinning.

Together with this, there is a metal tub supporter (not shown) between the tub rear wall and the stator, having a shape in conformity with an exterior shape of the rear wall of the tub 2, to be fixedly secured to the rear wall of the tub at the time the stator is secured, for supporting a weight of the stator, and maintaining concentricity of the stator.

The stator 6 functions as an electromagnet when power is supplied thereto, when the rotor rotates by action of a rotating magnetic field between the magnets of the stator 6 and the rotor 5, and rotation power of the rotor 5 is transmitted to the drum through the rotation shaft 4.

Currently, keeping pace with capacity increase of the washing machine, though it is required to increase an output of the motor for rotating the drum too, such an increased output of the motor requires large sized rotor and stator, to increase size and weight of the motor, significantly.

Consequently, the inventor suggests a double rotor type motor disclosed in Korea Patent Laid Open No. 2001-0097204 (applied on Nov. 8, 2001) having a stator with coils wound on inside and outside, and a double rotor of an inner rotor and an outer rotor on an inner side and an outer side of the stator each with a gap from the stator respectively, for increasing the output.

As the double rotor type motor generates greater power, it is required that the double rotor type motor is mounted to the washing machine or the like, more rigidly. Accordingly, the present invention modifies a structure for mounting the double rotor type motor to the washing machine further.

### DISCLOSURE OF INVENTION

### Technical Problem

An object of the present invention is to provide a washing machine having a structure modified further for mounting a double rotor type motor thereto.

### Technical Solution

The object of the present invention can be achieved by providing a washing machine including a tub for holding washing water, a double rotor having an outer rotor with outer magnets supported on an inside circumferential surface, and an inner rotor on an inner side of the outer rotor with inner magnets supported on outside circumferential surface, a bearing housing having a hub at a rear of the tub for supporting a rotation shaft connected to the double rotor, and extensions from the hub fixed to an outer surface of the tub, and a stator having cores with opposite surfaces arranged to face the outer magnets and the inner magnets, a coil wound on an outside surface of each of the cores, with an insulating material applied to an outside surface, a molded portion insert molded to outside surfaces of the core and coil such that the opposite surfaces of the cores are exposed, and a fastening portion extended from the molded portion and secured to the hub.

The extensions are formed as one body with the hub. At least two or more than two extensions are formed at predetermined angular intervals along a circumferential direction of the hub. The hub and the fastening portion have at least one fastening hole formed at positions in correspondence to each other for fastening a fastening member. The tub includes brackets on a circumference, and ends of the extensions are fixed to the brackets, respectively. The brackets are fixed to the circumference of the tub of metal by welding. The ends of the extensions are fixed to the brackets by fastening fastening members.

The fastening portion is insert molded as one body with the molded portion. The fastening portion is extended inwardly in a radial direction from the molded portion, or the fastening portion is extended outwardly in a radial direction from the molded portion.

The tub includes beads at a rear surface for reinforcing strength of the tub. The bearing housing includes beads at an outside surface for reinforcing strength of the bearing housing.

The washing machine further includes a positioning unit for determining a fastening position of the fastening portion with respect to the hub. The positioning unit includes at least one positioning projection projected from one of the hub and the fastening portion, and at least one positioning hole formed in the other one of the hub and the fastening portion in correspondence to the positioning projection. The positioning projection includes a cylindrical body portion, and a guide portion at an end of the body portion having a diameter reduced the more as it goes toward an end the more. The positioning hole includes a cylindrical portion in correspondence to the body portion, and a reduced portion at an end of the cylindrical portion in correspondence to the guide portion. The positioning hole has a diameter smaller than a diameter of the fastening hole in the fastening portion.

The fastening portion includes a reinforcing portion for reinforcing strength of the fastening portion. The reinforcing portion includes a plurality of reinforcing ribs formed as one body with the fastening portion at an outside surface. The washing machine further includes an insulator of an insulating material between the core and the molded portion.

In the meantime, in another aspect of the present invention, a washing machine includes a tub for holding washing Mater, a double rotor having an outer rotor with outer magnets supported on an inside circumferential surface, and an inner rotor on an inner side of the outer rotor with inner magnets supported on outside circumferential surface, a bearing housing having a hub at a rear of the tub for supporting a rotation shaft connected to the double rotor, and extensions extended in a radial pattern from the hub fixed to an outer surface of the tub, and a stator having cores with opposite surfaces arranged to face the outer magnets and the inner magnets, an insulator of an insulating material on an outside surface of each of the cores, a coil wound on an outside surface of each of the insulators, a molded portion insert molded to outside surfaces of the core and coil as one body such that the opposite surfaces of the cores are exposed, and a fastening portion extended as one body in a radial direction from the molded portion and secured to the hub.

In another aspect of the invention, a washing machine includes a tub for holding washing water, a double rotor having an outer rotor with outer magnets supported on an inside circumferential surface, and an inner rotor on an inner side of the outer rotor with inner magnets supported on outside circumferential surface, a bearing housing having a hub at a rear of the tub for supporting a rotation shaft connected to the double rotor, and extensions from the hub fixed to an outer surface of the tub, and a stator having cores with opposite surfaces arranged to face the outer magnets and the inner magnets, an insulator of an insulating material on an outside surface of each of the cores, a coil wound on an outside surface of each of the insulators, and a fastening portion extended from the insulator in a radial direction and fixed to the hub.

### Advantageous Effects

The washing machine having the double rotor type motor applied thereto has the following advantages.

First, the securing to the rear of the tub by means of the plurality of extensions along the radial direction of the bearing housing permits securer fixation of the double rotor type motor that has a greater rotation torque.

Second, the positioning unit at the bearing housing and the stator permits to shorten a time period required for aligning the bearing housing and the stator, thereby reducing a production time period.

Third, the easier fixation of the double rotor type motor to the rear of the tub with a bracket welded to the tub improves productivity even in a case the tub is formed of metal, thereby improving productivity.

Thus, by improving a structure for mounting a motor to the washing machine such that driving power is transmitted from the motor to the drum directly, the present invention reduces noise and faults, as well as a power loss, to improve washing capability and product reliability, and to improve processability of components of the driving unit, to improve productivity in fabrication of the product.

### BRIEF DESCRIPTION OF THE DRAWINGS

FIG. 1 illustrates a section of a related art washing machine;

FIG. 2 illustrates a section of a structure for mounting a double rotor type motor in accordance with a preferred embodiment of the present invention;

FIG. 3 illustrates an exploded perspective view of a double rotor type motor in accordance with a preferred embodiment of the present invention;

FIG. 4 illustrates a plan view of a tub rear portion in accordance with a preferred embodiment of the present invention; and

FIG. 5 illustrates a section of a structure for mounting a double rotor type motor in accordance with another preferred embodiment of the present invention.

### BEST MODE FOR CARRYING OUT THE INVENTION

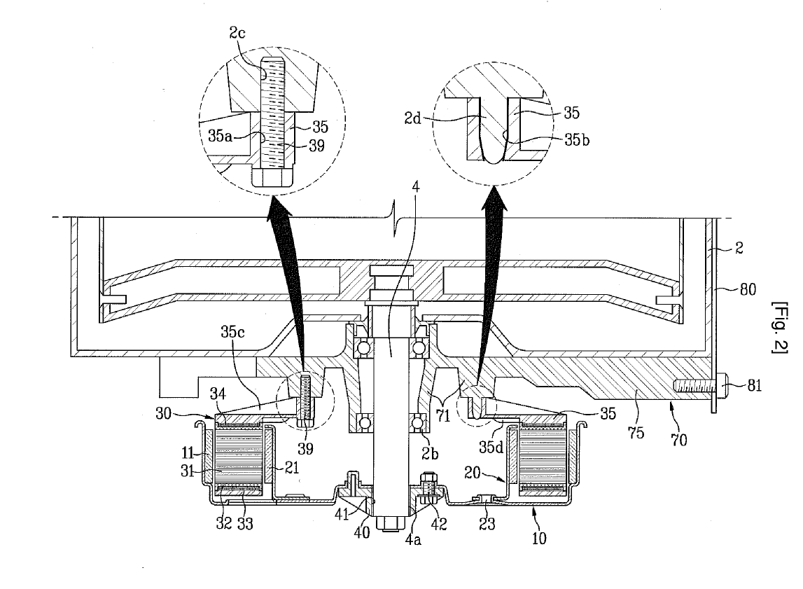

Reference will now be made in detail to the preferred embodiments of the present invention, examples of which are illustrated in the accompanying drawings FIGS. 2 to 5.

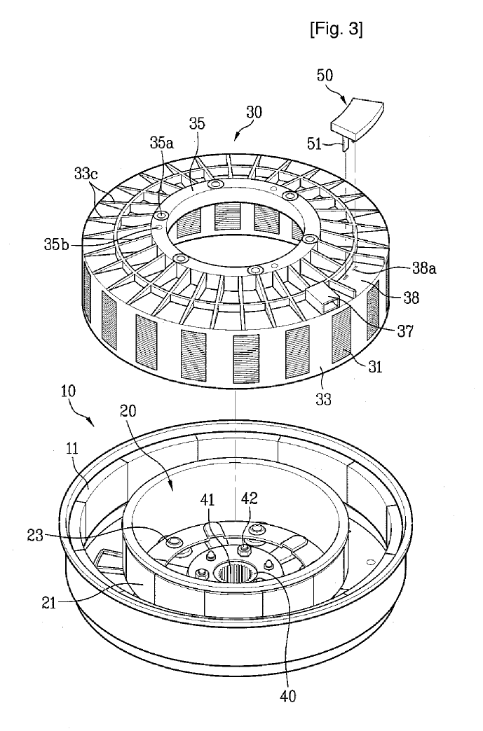

FIG. 2 illustrates a section of a structure for mounting a double rotor type motor in accordance with a preferred embodiment of the present invention, and FIG. 3 illustrates an exploded perspective view of a double rotor type motor in accordance with a preferred embodiment of the present invention.

Referring to FIGS. 2 and 3, the double rotor type motor includes an outer rotor 10, an inner rotor 20, and a stator 30. Placed between the outer rotor 10 and the inner rotor 20, there is the stator 30, and a top side of the stator 30 is fixedly secured to a rear of a washing machine tub.

In more detail, the top side of the stator 30 is fixedly secured to one side of a bearing housing ‘B’ mounted to a rear of the stator, and a bottom side of the stator 30 is placed between the outer rotor 10 and the inner rotor 20. In this instance, an outside circumferential surface and an inside circumferential surface of the stator 30 have pre-determined gaps to an inside circumferential surface of the outer rotor and an outside circumferential surface of the inner rotor, respectively. As shown in FIG. 3, at one side of the stator 30, there is a hall sensor 50 for detecting a rotation speed of the double rotor. The hall sensor 50 has a sensing portion 51 inserted through a hole 38a in one side of the stator for detecting the rotation speed of the double rotor.

The stator 30 includes cores 31 exposed opposite to outer magnets 11 on the outer rotor 10 and inner magnets 21 on the inner rotor 20 and from an inside and an outside of the stator 30, respectively. It is preferable that the outer magnets 11 and the inner magnets 21 are permanent magnets and the cores 31 are electromagnets.

According to this, because rotating magnetic fields are formed doubly between the inner magnets 21 and the insides of the cores 31 and between the outer magnets 11 and the outsides of the cores 31, the double type rotor can be rotated with a stronger torque.

The stator 30 has a plurality of individual split cores 31, an insulator 32 of an insulating resin encapsulating each of the cores 31, a coil 34 wound on an outside of the insulator 32, and a molded portion 35c insert molded to outside surfaces of the insulator 32 and the coil 34. If the coil 34 has an insulating material, such as enamel, applied to the outside of the coil 34 to secure an electrical insulation, no insulator 32 may be provided, separately.

The outer rotor 10 has the inner magnets 11 of a plurality of permanent magnets having N poles and S poles arranged on an inside circumferential surface in a circumferential direction, alternately. The inner rotor 20 has the outer magnets of a plurality of permanent magnets having N poles and S poles arranged on an outside circumferential surface in a circumferential direction alternately opposite to the inner magnets 21. It is preferable that lower portions of the outer rotor 10 and the inner rotor 20 in contact to each other are joined by a caulking hole portion 23 formed by pressing and caulking.

Though the inner rotor 20 and the outer rotor 10 may be formed by injection molding, it is preferable that the inner rotor 20 and the outer rotor 10 are formed of metal for serving as back yokes.

A structure for mounting the double rotor type motor will be described.

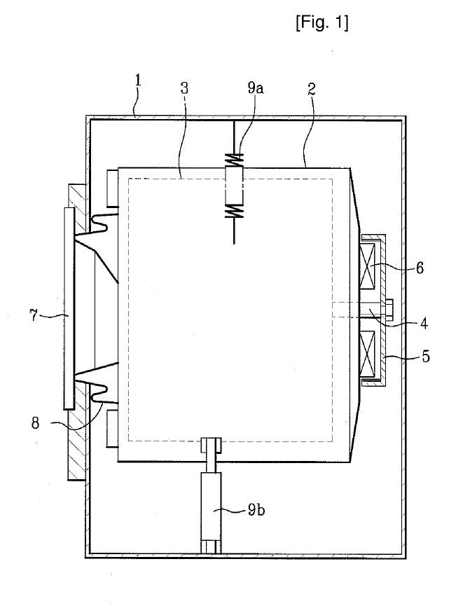

Referring to FIG. 2, the drum 3 or the pulsator or the like, rotatably mounted to a center of a rear of the tub 2 (see FIG. 1) of the washing machine, is connected to the rotation shaft 4. The rotation shaft 4 is rotatably supported on bearings 2b in the bearing housing 70 on a rear of the tub 2. The rotation shaft 4 has an end connected to a bushing 10 of resin at a center of the outer rotor I0. Though the bushing 40 is fixedly secured to a center of the outer rotor 10 with fastening means, such as bolts 42, the bushing 40 may be formed as one unit with the outer rotor 10 by a method, such as insert molding.

The bushing 40 has a hole at a center for placing the rotation shaft 4 therein, with a bushing side serration 41 on an inside circumferential surface for engagement with the serration 4a on an outside circumferential surface of the rotation shaft 4.

In the meantime, for fastening the stator 30 to the bearing housing 70, it is preferable that the stator 30 has a fastening portion 35 extended inwardly from the molded portion 33 in a radial direction. Of course, different from what is shown in the drawing, the fastening portion 35 may be extended outwardly from the molded portion 33 in a radial direction.

The fastening portion 35 is formed as one unit with the molded portion 33 by insert molding, and has a plurality of fastening holes 35a at predetermined angular intervals in a circumferential direction. The bearing housing 70 also has fastening holes 2c in correspondence to the fastening holes 35a in the fastening portion 35, so that the stator 30 is fixedly secured to the bearing housing 70 as fastening members, such as bolts 39, or the like, are passed through the fastening holes 35a, and 2c, and fastened.

Moreover, it is preferable that the fastening portion 35 has a reinforcing portion of a plurality of reinforcing ribs 35c on an outside surface for reinforcing strength of the fastening portion 35. It is preferable that reinforcing ribs 35d are formed at an inside corner of a point where the molded portion 33 and the fastening portion 35 meet as far as the reinforcing ribs 35d do not interfere rotation of the inner rotor 20.

Of course, without forming the reinforcing ribs 35c as described before, an annular metal bracket (not shown) may be attached to an inside or outside surface of the fastening portion 35 for reinforcing the fastening portion 35.

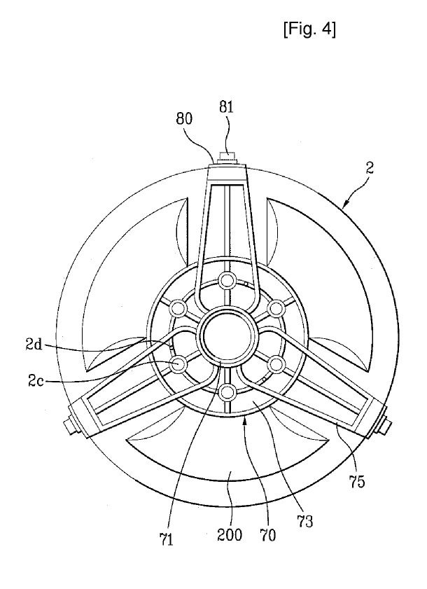

FIG. 4 illustrates a plan view of a tub rear portion in accordance with a preferred embodiment of the present invention.

Referring to FIGS. 2 and 4, the bearing housing 70 includes a hub 71 at a center for placing in, and supporting the rotation shaft 4, and extensions 75 extended from the hub 71 in a radial direction and fixed to an outer side of the tub 2. On an inside of the hub 71, there are bearing 2b for supporting the rotation shaft 4.

At least two or more than two extensions 75 are formed at predetermined thickness on a rear of the tub 2 in predetermined angular intervals in a circumferential direction. It is preferable that the hub 71 and the extensions 75 are formed as one body, recessed, or projected beads 73 are formed on an outside surface of the bearing housing 70 having the hub 71 and the extensions 75 for reinforcing the bearing housing 70.

It is preferable that the tub 2 is formed of metal, and ends of the extensions 75 are fixed to brackets 80 on an outside circumferential surface of the tub 2, respectively. It is preferable that the brackets 80 are welded to the outside circumferential surface of the tub 2 of metal, and the ends of the extensions 75 are fastened to the brackets 80 with fastening members, such as bolts 81 or the like, respectively.

Moreover, in order to reinforcing the rear of the tub 2, recessed, or projected beads 200 of predetermined depths are formed on the rear of the tub 2.

As described before, the hub 71 has the fastening holes 2c in correspondence to the fastening holes 35a (see FIG. 3) in the fastening portion 35 of the stator 30, for coupling the stator 30 to the bearing housing 70 with fastening members, such as bolts 81 or the like, fastened through the fastening holes 35a, and 2c.

In the meantime, it is required that the stator 30 is coupled to the bearing housing 70 with an exact concentricity with respect to the rotation shaft 4. For this, both the fastening portion 35 and the hub 71 have a positioning unit for aligning the concentricity.

Referring to FIGS. 2 to 4, the positioning unit includes positioning projections 2d and positioning holes 35b. A plurality of the positioning projections 2d are formed projected from one side of each of the fastening holes 2c in the hub 71 at pre-determined intervals. It is preferable that the fastening portion 35 has the positioning holes 35b formed therein in correspondence to the positioning projections 2d such that the positioning projections 2d fit to the positioning holes 35b. The positioning holes 35b may be pass through holes formed to pass through the fastening portion 35.

Of course, opposite to above, the positioning holes may be formed in the hub of the bearing housing 70, and the positioning projections may be formed on the fastening portion 35.

The positioning projection 2d includes a cylindrical body portion, and a conical guide portion at an end of the body portion for easy placing of the positioning projection in the positioning hole 35b.

It is preferable that the positioning hole 35b is formed in conformity with a shape of the positioning projection 2d so that the positioning projection 2d fits in the positioning hole 35b without movement once the positioning projection 2d is placed in the positioning hole 35b.

That is, it is preferable that a portion of the positioning hole 35b where the body portion of the positioning projection 2d is to be placed therein is cylindrical in correspondence to the body portion, and a portion where the guide portion of the positioning projection 2d is to be placed therein is conical. It is also preferable that the positioning hole 35b in the fastening portion 35 has a diameter smaller than a diameter of the fastening hole 35a.

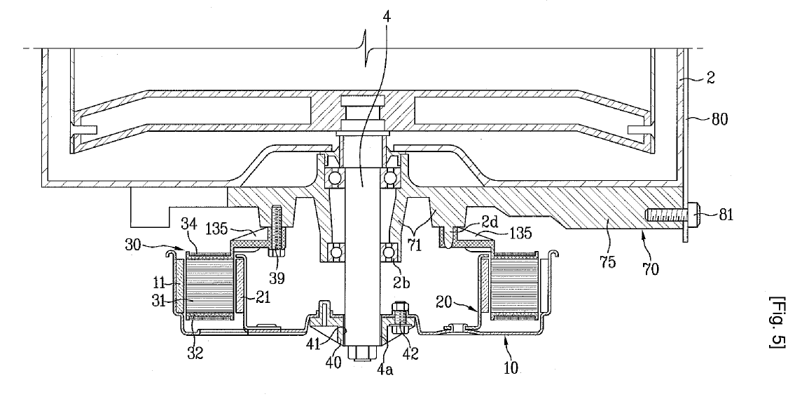

In the meantime, FIG. 5 illustrates a section of a structure for mounting a double rotor type motor in accordance with another preferred embodiment of the present invention.

Referring to FIG. 5, the double rotor type motor of the embodiment includes no molded portion formed individually at the stator 30, but a fastening portion 135 extended from the insulator 32 on an outside surface of the core 31. Accordingly, the bearing housing 70 mounted to the rear of the tub 2 has a structure the same with the foregoing embodiment, and description of which will be omitted. The reinforcing ribs and the positioning unit at the fastening portion 135 are the same with the foregoing embodiment.

As shown, the fastening portion 135 of the stator 30, joined with the hub 71 of the bearing housing 70, is extended inwardly in a radial direction from the insulator 32. Of course, different from what is shown, the fastening portion may be extended outwardly in a radial direction from the insulator 32.

It is preferable that the fastening portion 135 is insert molded with the insulator 32 as one body. Moreover, the fastening portion 135 has reinforcing ribs 135a for reinforcing the fastening portion 135.

As described, the double rotor type motor of the present invention is fastened, and secured to the bearing housing at the rear of the tub, and the bearing housing can be secured to the tub rigidly with the plurality of the extensions along the circumferential direction inbetween.

### Industrial Applicability

The present invention relates to washing machines, and more particularly, to a washing machine with a double rotor type motor. The washing machine having the double rotor type motor of the present invention applied thereto has the following advantages.

First, the securing to the rear of the tub by means of the plurality of extensions along the radial direction of the bearing housing permits securer fixation of the double rotor type motor that has a greater rotation torque.

Second, the positioning unit at the bearing housing and the stator permits to shorten a time period required for aligning the bearing housing and the stator, thereby reducing a production time period.

Third, the easier fixation of the double rotor type motor to the rear of the tub with a bracket welded to the tub improves a productivity even in a case the tub is formed of metal, thereby improving productivity.

Thus, by improving a structure for mounting a motor to the washing machine such that driving power is transmitted from the motor to the drum directly, the present invention reduces noise and faults, as well as a power loss, to improve washing capability and product reliability, and to improve processability of components of the driving unit, to improve productivity in fabrication of the product.

1. A washing machine comprising:
a tub for holding washing water;
a double rotor having an outer rotor with outer magnets supported on an inside circumferential surface, and an inner rotor on an inner side of the outer rotor with inner magnets supported on outside circumferential surface;
a bearing housing having a hub at a rear of the tub for supporting a rotation shaft connected to the double rotor, and extensions from the hub fixed to an outer surface of the tub; and
a stator having cores with opposite surfaces arranged to face the outer magnets and the inner magnets, a coil wound on an outside surface of each of the cores, with an insulating material applied to an outside surface, a molded portion insert molded to outside surfaces of the core and coil such that the opposite surfaces of the cores are exposed, and a fastening portion extended from the molded portion and secured to the hub.

2. The washing machine as claimed in claim 1, wherein the extensions are formed as one body with the hub.

3. The washing machine as claimed in claim 1, wherein at least two or more than two extensions are formed at predetermined angular intervals along a circumferential direction of the hub.

4. The washing machine as claimed in claim 1, wherein the hub and the fastening portion have at least one fastening hole formed at positions in correspondence to each other for fastening a fastening member.

5. The washing machine as claimed in claim 1, wherein the tub includes brackets on a circumference, and ends of the extensions are fixed to the brackets, respectively.

6. The washing machine as claimed in claim 5, wherein the brackets are fixed to the circumference of the tub by welding.

7. The washing machine as claimed in claim 5, wherein the ends of the extensions are fixed to the brackets by fastening fastening members.

8. The washing machine as claimed in claim 1, wherein the fastening portion is insert molded as one body with the molded portion.

9. The washing machine as claimed in claim 1, wherein the fastening portion is extended inwardly in a radial direction from the molded portion.

10. The washing machine as claimed in claim 1, wherein the fastening portion is extended outwardly in a radial direction from the molded portion.

11. The washing machine as claimed in claim 1, wherein the tub includes beads at a rear surface for reinforcing strength of the tub.

12. The washing machine as claimed in claim 1, wherein the bearing housing includes beads at an outside surface for reinforcing strength of the bearing housing.

13. The washing machine as claimed in claim 1, further comprising a positioning unit for determining a fastening position of the fastening portion with respect to the hub.

14. The washing machine as claimed in claim 13, wherein the positioning unit includes;
at least one positioning projection projected from one of the hub and the fastening portion, and
at least one positioning hole formed in the other one of the hub and the fastening portion in correspondence to the positioning projection.

15. The washing machine as claimed in claim 14, wherein the positioning projection includes;
a cylindrical body portion, and
a guide portion at an end of the body portion having a diameter reduced the more as it goes to and an end the more.

16. The washing machine as claimed in claim 14, wherein the positioning hole includes;
a cylindrical portion in correspondence to the body portion, and
a reduced portion at an end of the cylindrical portion in correspondence to the guide portion.

17. The washing machine as claimed in claim 14, wherein the positioning hole has a diameter smaller than a diameter of the fastening hole in the fastening portion.

18. The washing machine as claimed in claim 1, wherein the fastening portion includes a reinforcing portion for reinforcing strength of the fastening portion.

19. The washing machine as claimed in claim 18, wherein the reinforcing portion includes a plurality of reinforcing ribs formed as one body with the fastening portion at an outside surface.

20. The washing machine as claimed in claim 1, further comprising an insulator of an insulating material between the core and the molded portion.

21. A washing machine comprising:
a tub for holding washing water;
a double rotor having an outer rotor with outer magnets supported on an inside circumferential surface, and an inner rotor on an inner side of the outer rotor with inner magnets supported on outside circumferential surface;
a bearing housing having a hub at a rear of the tub for supporting a rotation shaft connected to the double rotor, and extensions extended in a radial pattern from the hub fixed to an outer surface of the tub; and
a stator having cores with opposite surfaces arranged to face the outer magnets and the inner magnets, an insulator of an insulating material on an outside surface of each of the cores, a coil wound on an outside surface of each of the insulators, a molded portion insert molded to outside surfaces of the core and coil as one body such that the opposite surfaces of the cores are exposed, and a fastening portion extended as one body in a radial direction from the molded portion and secured to the hub.

22. A washing machine comprising:
a tub for holding washing water;
a double rotor having an outer rotor with outer magnets supported on an inside circumferential surface, and an inner rotor on an inner side of the outer rotor with inner magnets supported on outside circumferential surface;
a bearing housing having a hub at a rear of the tub for supporting a rotation shaft connected to the double rotor, and extensions from the hub fixed to an outer surface of the tub; and
a stator having cores with opposite surfaces arranged to face the outer magnets and the inner magnets, an insulator of an insulating material on an outside surface of each of the cores, a coil wound on an outside surface of each of the insulators, and a fastening portion extended from the insulator in a radial direction and fixed to the hub.
